(19) United States
(12) Patent Application Publication
(10) Pub. No.: US 2007/0056688 A1
(43) Pub. Date: Mar. 15, 2007

(54) Methods of treating deposition process components to form particle traps, and deposition process components having particle traps thereon

(76) Inventors: Jaeyeon Kim, Liberty Lake, WA (US); Terry J. Phelan, Missoula, MT (US); Janine K. Kardokus, Veradale, WA (US); Scott R. Sayles, Mead, WA (US)

Correspondence Address: WELLS ST. JOHN P.S., 601 WEST FIRST AVE, SUITE 1300, SPOKANE, WA, 99201, US

(21) Appl. No.: 10/566,691

(22) PCT Filed: Sep. 10, 2004
(86) PCT No.: PCT/US04/29387

§ 371 Date: Aug. 22, 2006

Related U.S. Application Data
(60) Provisional application No. 60/505,689, filed on Sep. 23, 2003.
(60) Provisional application No. 60/543,457, filed on Feb. 9, 2004.

(51) Int. Cl. B32B 37/00

(52) U.S. Cl. 156/293

(57) ABSTRACT

The invention includes methods for forming particle traps along surfaces of PVD components, and comprises PVD components having particle traps thereon. The invention can include utilization of highly soluble media for bead-blasting and/or can include utilization of metallic materials as bead-blasting media. The invention can also include formation of an insert along regions of a backing plate where particle traps are desired, with the insert being of a composition which has better particle-trapping properties than the backing plate.

### RELATED APPLICATION DATA

This application claims priority to U.S. Provisional Application 60/502,689, which was filed on Sep. 11, 2003; and also claims priority to U.S. Provisional Application 60/543,457, which was filed on Feb. 9, 2004.

### TECHNICAL FIELD

The invention pertains to methods of forming particle traps along regions of physical vapor deposition (PVD) process components, such as, for example, sputter targets.

### BACKGROUND OF THE INVENTION

PVD methods are utilized for forming films of material across substrate surfaces. PVD methods can be utilized in, for example, semiconductor fabrication processes to form layers ultimately utilized in fabrication of integrated circuitry structures and devices.

A PVD operation is described with reference to a sputtering apparatus 110 in FIG. 1. Apparatus 110 is an example of an ion metal plasma (IMP) apparatus, and comprises a chamber 112 having sidewalls 114. Chamber 112 is typically a high vacuum chamber. A target 10 is provided in an upper region of the chamber, and a substrate 118 is provided in a lower region of the chamber. Substrate 118 is retained on a holder 120, which typically comprises an electrostatic chuck. Target 10 would be retained with suitable supporting members (not shown), which can include a power source. An upper shield (not shown) can be provided to shield edges of the target 10. Target 10 can comprise, for example, one or more of indium, tin, nickel, tantalum, titanium, copper, aluminum, silver, gold, niobium, platinum, palladium, tungsten and ruthenium, including one or more alloys of the various metals. The target can be a monolithic target, or can be part of a target/backing plate assembly.

Substrate 118 can comprise, for example, a semiconductor wafer, such as, for example, a single crystal silicon wafer.

Material is sputtered from a surface of target 10 and directed toward substrate 118. The sputtered material is represented by arrows 122.

Generally, the sputtered material will leave the target surface in a number of different directions. This can be problematic, and it is preferred that the sputtered material be directed relatively orthogonally to an upper surface of substrate 118. Accordingly, a focusing coil 126 is provided within chamber 112. The focusing coil can improve the orientation of sputtered materials 122, and is shown directing the sputtering materials relatively orthogonally to the upper surface of substrate 118.

Coil 126 is retained within chamber 112 by pins 128 which are shown extending through sidewalls of the coil and also through sidewalls 114 of chamber 112. Pins 128 are retained with retaining screws 132 in the shown configuration. The schematic illustration of FIG. 1 shows heads 130 of the pins along an interior surface of coil 126, and another set of heads 132 of the retaining screws along the exterior surface of chamber sidewalls 114.

Spacers 140 (which are frequently referred to as cups) extend around pins 128, and are utilized to space coil 126 from sidewalls 114.

Problems can occur in deposition processes if particles are formed, in that the particles can fall into a deposited film and disrupt desired properties of the film. Accordingly, it is desired to develop traps which can alleviate problems associated with particles falling into a desired material during deposition processes.

Some efforts have been made to modify PVD targets to alleviate particle formation. For instance, bead-blasting has been utilized to form a textured surface along sidewalls of a target with the expectation that the textured surface will trap particles formed along the surface. Also, knurling and machine scrolling have been utilized to form textures on target surfaces in an effort to create appropriate textures that will trap particles.

Although some of the textured surfaces have been found to reduce particle formation, problems exist with various of the textured surfaces. For instance, bead-blasting typically utilizes particles blasted at the target with high force. Some of the particles from the blasting can be imbedded in the target material during the blasting process, and remain within the target material as it is inserted in a PVD chamber. The surfaces of the beads can have relatively poor adhesion for re-deposited material entering a particle-trapping region, and can thus degrade performance of the particle-trapping region.

It would be desirable to develop new methodologies to reduce, and preferably eliminate, problems associated with embedded bead-blasted particles in particle-trapping regions. It would be desirable for the new methodologies to be applicable for utilization with particle-trapping regions associated with non-sputtered surfaces of numerous components within a chamber that may be exposed to sputtered material, including, but not limited to, surfaces of one or more of internal sidewalls of a chamber, coils, cover rings, clamps, shields, pins, cups, etc.; in addition to, or alternatively to, the utilization of the new methodologies for forming particle-trapping regions on non-sputtered surfaces of PVD targets.

### SUMMARY OF THE INVENTION

In one aspect, the invention encompasses solubilization of bead-blasting media to remove the media after a bead-blasting process. The media is initially provided in particulate form and utilized for bead-blasting to roughen a surface. The bead-blasting media is highly soluble in a solvent, and subsequently the bead-blasted surface is exposed to the solvent to dissolve bead-blasted media that may be associated with the roughened surface. Exemplary media can include ammonium chloride, and various halide salts comprising elements from groups 1A and 2A of the Periodic Table. In particular aspects, the media can comprise one or more alkali halide salts, such as, for example, sodium chloride or potassium chloride, and in such applications the solvent utilized for removing the media can be an aqueous solution. Other exemplary media can comprise organic materials (such as, for example, organometallic materials), and the solvent can comprise an organic solvent suitable for dissolving the organic materials.

In one aspect, the invention pertains to utilization of metals for bead-blasting. The bead-blasting is utilized to roughen a surface of a PVD component. Such a surface can comprise metal (either in the form of elemental metal, or in the form of an alloy), and the metals utilized for the bead-blasting can be harder than the metal of the PVD component surface. In particular aspects, the metals utilized for the bead-blasting are in relatively pure form, and specifically have a metal content which is 99% pure (by weight) or higher.

In one aspect, the invention encompasses a target/backing plate construction having a non-sputtered region extending along a peripheral side of the target and along a flange proximate the target. The construction includes an insert provided within the flange and comprising a material suitable for utilization in forming a particle trap. In exemplary aspects, the target can comprise tantalum, the backing plate can comprise copper, and the insert can comprise one or more of aluminum, titanium and tantalum.

### BRIEF DESCRIPTION OF THE DRAWINGS

FIG. 1 is a diagrammatic, cross-sectional view of a prior art physical vapor deposition apparatus shown during a physical vapor deposition (e.g., sputtering) process.

FIG. 2 is a diagrammatic, top view of an exemplary target construction suitable for utilization in methodology of the present invention.

FIG. 3 is a diagrammatic, cross-sectional view along the line 3-3 of FIG. 2.

FIG. 4 is a view of an expanded region of the FIG. 3 target construction (the region labeled 4 in FIG. 3), and shown at a preliminary processing stage of an exemplary method of the present invention.

FIG. 5 is a view of the FIG. 4 expanded region shown at a processing stage subsequent to that of FIG. 4.

FIG. 6 is a view of the FIG. 4 expanded region shown at a processing stage subsequent to that of FIG. 5.

FIG. 7 is an expanded view of a portion of the FIG. 6 structure.

FIG. 8 is a view of the FIG. 4 expanded region shown at a processing stage subsequent to that of FIG. 6.

FIG. 9 is an expanded view of a portion of the FIG. 8 structure.

FIG. 10 is a diagrammatic, top view of an exemplary target/backing plate construction suitable for utilization in methodology of the present invention.

FIG. 11 is a diagrammatic, cross-sectional view along the line 11-11 of FIG. 10.

FIG. 12 is a diagrammatic, cross-sectional view of an exemplary target/backing plate construction in accordance with an aspect of the present invention.

FIG. 13 is a diagrammatic, cross-sectional view of an exemplary target/backing plate construction in accordance with an aspect of the present invention similar to that of FIG. 12.

FIG. 14 is a diagrammatic, top view of the target/backing plate construction of FIG. 13, along the line 14-14 of FIG. 13.

### DETAILED DESCRIPTION OF THE PREFERRED EMBODIMENTS

The invention encompasses particle-trapping regions which can be formed on one or more surfaces of a PVD component, and methods of forming the particle-trapping regions. The particle-trapping regions can be utilized for trapping materials which deposit on the component during a deposition process.

The particle-trapping regions are formed by treating one or more surfaces of the PVD component with bead blasting, and in some aspects also with machine tooling. If the treated component is a sputtering target, the treated surfaces can include any non-sputtered surfaces, such as, for example, sidewall surfaces, flange surfaces and/or non-sputtered surfaces along a sputtering face.

Projections formed with machine tooling can be considered to correspond to a macro-scale roughness, and roughening accomplished by bead blasting can be considered to correspond to a micro-scale roughness. Thus, the invention can include patterns which have one or both of macro-scale and micro-scale roughness, and which are utilized in trapping regions.

The utilization of both macro-scale and micro-scale patterns can be advantageous. The combined macro-scale pattern and micro-scale pattern can significantly reduce material fall-off from a treated surface of a component during a deposition process. Also, the formation of a micro-scale roughened surface on the macro-scale pattern can effectively reduce the problems of fall-off from the deposited film through reduction of planar or linear deposited film. The planar or linear films can be particularly weak with respect to cyclic thermal stresses occurring during cyclic deposition processes. Specifically, a macro-scale pattern alone (such as, for example, a long machined scroll) can trap redeposited materials to form a long film within a trapping region. Cyclic thermal stresses (such as stress associated with, for example, a different thermal expansion coefficient of the redeposited film versus the base material of the treated component), can lead to peeling of the film or clusters of redeposited film from the treated component. As the film or cluster peels from the component, it can fall onto a substrate proximate the component to undesirably form particles within a layer deposited on the substrate during a deposition process, which can decrease throughput or yield of the deposition process.

Although it can be advantageous to impart both macro-scale and micro-scale roughness to a surface, there can also be aspects in which micro-scale roughness alone is desired for trapping. Accordingly, the invention also includes aspects in which micro-scale roughness is formed on one or more surfaces of a sputtering component without macro-scale roughness. Alternatively, the invention can include aspects in which macro-scale roughness is formed on one or more surfaces of a sputtering component without micro-scale roughness.

An exemplary aspect of the invention is described below with reference to FIGS. 2-9 for treating a component of a PVD process (specifically for treating non-sputtered surfaces of a sputtering target).

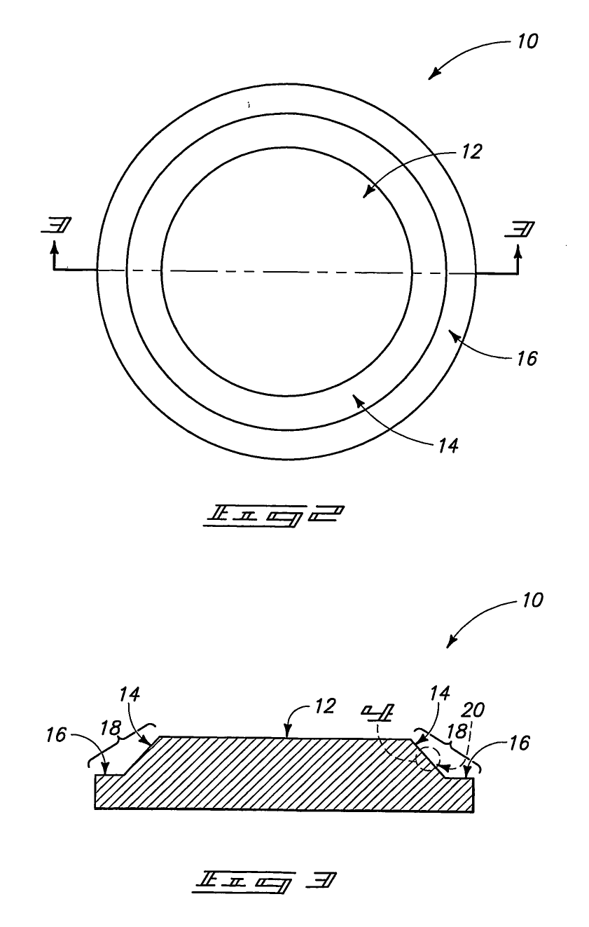

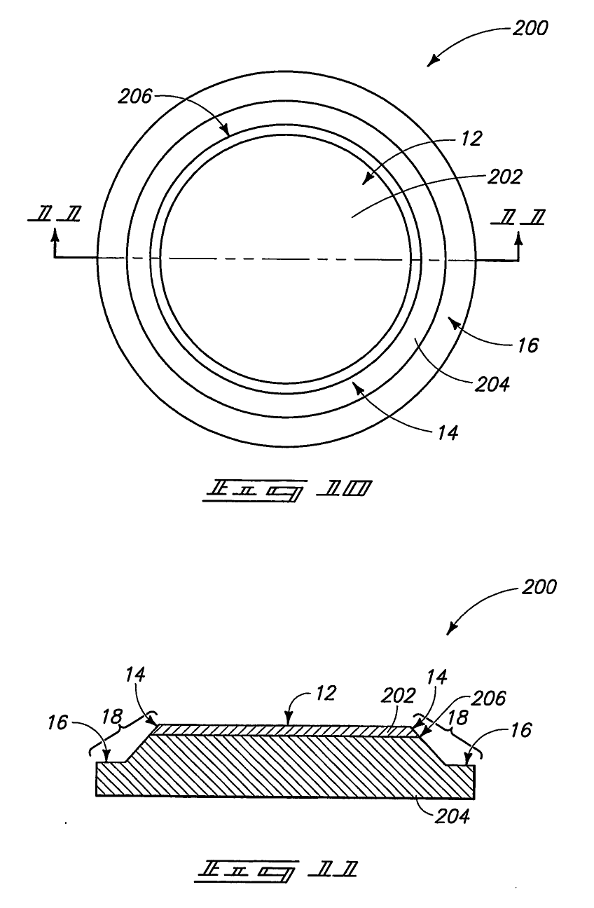

Referring to FIGS. 2 and 3, an exemplary sputtering target construction 10 is illustrated in top view (FIG. 2) and cross-sectional side view (FIG. 3). Construction 10 is shown as a monolithic physical vapor deposition target in the exemplary aspect of the invention, but it is to be understood that construction 10 can alternatively be a target/backing plate construction (exemplary target/backing plate constructions are shown in FIGS. 10-14). Target construction 10 comprises a sputtering face 12 and sidewalls 14 proximate the sputtering face. Construction 10 also comprises a flange 16 extending around a lower region of the target construction. Construction 10 is shown as a VECTRA-IMP^{TM}-type target, such as is available from Honeywell International Inc., but it is to be understood that other target constructions can be utilized in various aspects of the present invention.

Sputtering face 12 will generally have both a region from which materials are sputtered in a PVD operation and a region from which materials are not sputtered in the PVD operation. The non-sputtering region can encompass, for example, a region proximate sidewall 14 corresponding to a laterally peripheral region of face 12.

As discuss above, a problem with utilizing target construction 10, or other target configurations, in sputtering operations is that some materials sputtered from face 12 can redeposit on other surfaces of the target construction (such as non-sputtered regions including the sidewalls 14, flange 16 and non-sputtered regions of face 12). The redeposited material can ultimately fall from the target construction as particles during a PVD operation. The particles can deposit within a layer sputter-deposited during the PVD operation to detrimentally affect properties of the layer, and/or can fall onto an electrostatic chuck provided to support a substrate. It is therefore desired to develop methods for treating the sidewalls and/or flange and/or other non-sputtered surfaces of the target to avoid particle contamination of a sputter-deposited layer.

In accordance with an aspect of the present invention, surfaces of face 12 (the non-sputtered surfaces), sidewall 14 and/or flange 16 are treated by new methodologies to alleviate particle formation. The treated regions can, for example, extend partially or entirely across the regions indicated by brackets 18 in FIG. 3. It can be particularly preferred to utilize methodology of the present invention to treat all non-sputtered surfaces of a target (whether on the face 12, sidewall 14 or flange 16) that are exposed to a vacuum within a PVD reaction chamber.

FIG. 4 shows an expanded region 20 of sidewall 14. The sidewall has a relatively planar surface 21.

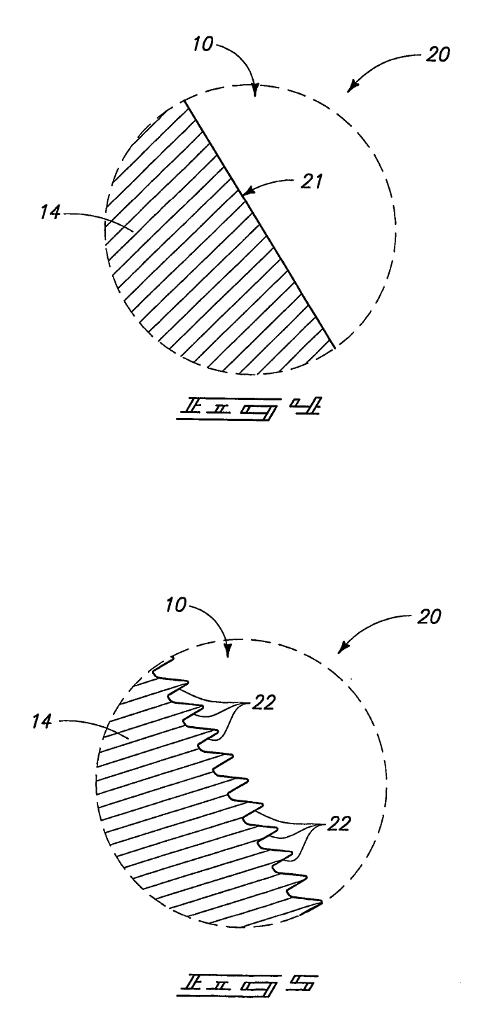

FIG. 5 illustrates expanded region 20 after sidewall 14 has been treated to form a pattern of projections 22 extending across a surface of the sidewall. Projections 22 can be formed utilizing a computer numerically controlled (CNC) tool, knurling device or other suitable machine tool, and can correspond to a scroll pattern. For example, a CNC tool can be utilized to cut into sidewall 14 and leave the shown pattern and/or a knurling device can be utilized to press into sidewall 14 and leave the pattern. The pattern is a repeating pattern, as opposed to a random pattern that would be formed by, for example, bead-blasting. The pattern of projections 22 can be referred to as a macropattern, to distinguish the pattern from a micropattern that can be subsequently formed (discussed below). The projections 22 can be formed to a density of from about 28 per inch to about 80 per inch, with about 40 per inch being typical. In particular applications the projections can be formed with a tool having from about 28 teeth per inch (TPI) to about 80 TPI, with about 40 TPI being typical. The teeth of the tool can be in a one-to-one correspondence with the projections 22. The projections 22 can be formed across a surface of flange 16 (FIG. 3) and/or non-sputtered regions of face 12 alternatively, or additionally to formation of the projections along the sidewall 14.

FIG. 6 shows expanded region 20 after the projections 22 have been subjected to a mechanical force which bends the projections over. The mechanical force can be provided by any suitable tool, including, for example, a ball or roller. The bent projections can also be formed utilizing suitable directional machining with a CNC tool. The bent projections define cavities 23 between the projections, and such cavities can function as traps for redeposited material and/or as traps for other sources of particles.

Referring again to FIG. 3, sidewall 14 can be considered to be proximate sputtering face 12, and to form a lateral periphery of target construction 10 around the sputtering face. The bent projections 22 (which can also be referred to as curved projections) of FIG. 6 can thus be understood to form cavities 23 which open laterally along the sidewall. The cavities 23 can alternatively be considered a repeating pattern of receptacles formed by the bent, or curved, projections 22. The receptacles 23 can ultimately be utilized for retaining redeposited materials, or other materials that could be one of the sources of particles during a PVD process. The receptacles 23 are shown in FIG. 6 to have inner surfaces 27 around an interior periphery of the receptacles.

If the sputtering surface 12 (FIG. 3) is defined as an upper surface of target construction 10 (i.e., if the target construction is considered in the orientation of FIG. 3), the shown cavities open downwardly. In other aspects of the invention (not shown) the curved projections can form cavities which open upwardly in the orientation of FIG. 3, or sidewardly. Accordingly, the invention encompasses aspects in which a sputtering face is defined as an upper surface of a target construction, and in which curved projections are formed along a sidewall of the target construction to form cavities which open laterally along the sidewall in one or more of a downward, upward and sideward orientation relative to the defined upper surface of the sputtering face. It is noted that the sputtering face is defined as an upper surface for purposes of explaining a relative orientation of the cavities formed by the curved projections, rather than as indicating any particular orientation of the target construction relative to an outside frame of reference. Accordingly, the sputtering surface 12 (FIG. 3) may appear as an upward surface of the target construction, downward surface of the target construction, or side surface of the target construction to a viewer external to the target construction; but for purposes of interpreting this disclosure, the surface can be considered a defined upper surface to understand the relationship of the sputtering surface to the directionality of the openings of the cavities 23 formed by curved projections 22.

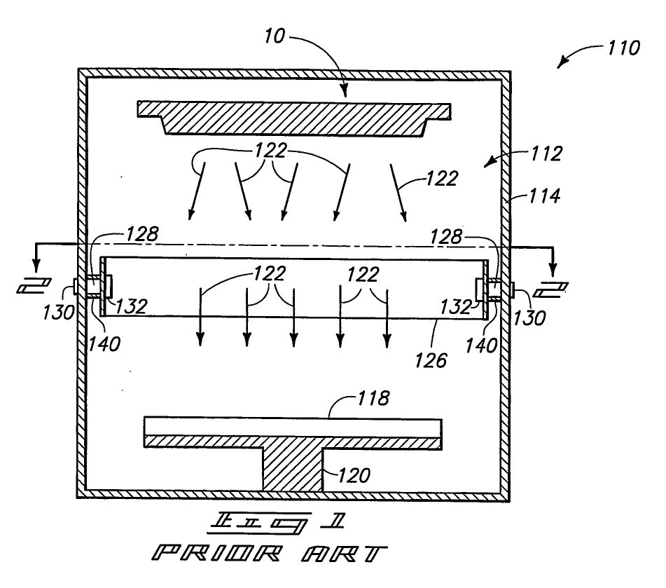

It can be advantageous that the cavities 23 open upwardly in the orientation in which target construction 10 is ultimately to be utilized in a sputtering chamber (such as, for example, the chamber 112 of FIG. 1). Accordingly, it can be advantageous that the cavities open in the shown downward configuration relative to a sputtering surface 12 defined as an upper surface of the target construction.

FIG. 7 illustrates an expanded region 30 of the FIG. 6 structure, and specifically illustrates a single projection 22.

The curved projections 22 of FIGS. 6 and 7 can have a height “H” above surface 21 of, for example, from about 0.0001 inch to about 0.1 inch (typically about 0.01 inch), and a repeat distance (“R”) of from about 0.001 inch to about 1 inch (typically about 0.027 inch). The distance “R” can be considered to be a periodic repeat distance of the curved projections 22.

In particular aspects, curved projections 22 can be considered to have bases 25 where the curved projections join to sidewall 14, and sidewall 14 can be considered to have a surface 15 extending between the bases of the curved projections. The curved projections will typically have a maximum height (“H”) above the sidewall surface 15 of from about 0.0001 inches to about 0.01 inches.

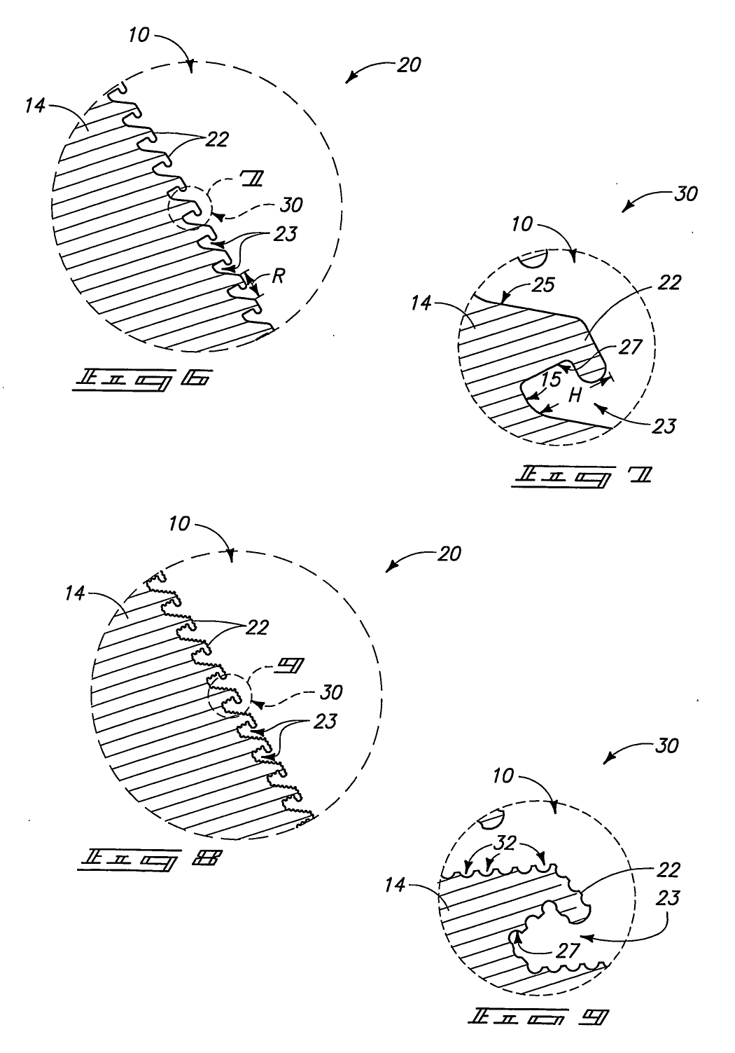

FIGS. 8 and 9 show the projections 22 after they have been treated to form microstructures 32 extending along the projections as cavities or divots. The treatment preferably extends into the receptacles 23 to roughen the inner surfaces 27 (as shown). The microstructures together define a microstructural roughness.

The treatment of projections 22 can utilize, for example, one or both of a chemical etchant and mechanical roughening. Exemplary mechanical roughening procedures include exposure to a pressurized stream of particles (e.g., bead-blasting), or exposure to rigid bristles (such as wire bristles). Exemplary chemical etchants include solutions which chemically pit the material of projections 22, and can include strongly basic solutions, weakly basic solutions, strongly acidic solutions, weakly acidic solutions, and neutral solutions.

If bead-blasting is utilized to form microstructures 32, the particles used to form the microstructures can comprise, for example, one or more of gamet, silicon carbide, aluminum oxide, solid H₂O (ice), solid carbon dioxide, and salt (such as, for example, a salt of bicarbonate, such as sodium bicarbonate). Additionally or alternatively, the particles can comprise one or more metallic materials at least as hard as the material in which the microstructures are to be formed.

If the particles utilized for the bead-blasting comprise a non-volatile material, a cleaning step can be introduced after formation of divots 32 to remove the particles. For instance, if the particles comprise silicon carbide or aluminum oxide, a cleaning step can be utilized wherein projections 22 are exposed to a bath or stream of cleaning material and/or are brushed with an appropriate brushing tool (such as a wire brush). A suitable stream can be a stream comprising solid H₂O or solid carbon dioxide particles. If the particles initially utilized to form divots 32 consist essentially of, or consist of, volatile particles (such as solid ice or solid CO₂), then the cleaning step described above can be omitted.

In some aspects the bead-blasting media can be 24 grit Al₂O₃ media, and the bead-blasting can be conducted to, for example, from about 1 to about 4000 micro-inch RA, preferably from about 50 to about 2000 micro-inch RA, and typically from about 100 to about 300 micro-inch RA.

In some aspects the bead-blasting media can comprise material which is highly soluble in an appropriate solvent. The bead-blasting media can then be removed from a treated surface using the solvent. Specifically, the bead-blasting media can comprise salts or other compositions which can be readily dissolved in appropriate solvents (such as, for example, aqueous solvents, alcohol solvents, non-polar organic solvents, etc.). The bead-blasting media can thus be substantially entirely removed from the surface with the appropriate solvent.

In an exemplary application of utilization of bead-blasting media which is soluble in an appropriate solvent, bead-blasting media can be used which comprises one or more halide salts containing elements from groups 1A and 2A of the periodic table (with groups 1A and 2A comprising lithium, sodium, potassium, rubidium, cesium, francium, beryllium, magnesium, calcium, strontium, barium and radium), and aqueous solvent can be used to clean the bead-blasting media from a treated surface. As will by understood by persons of ordinary skill in the art, the halide salts will comprise combinations of the elements from groups 1A and 2A with elements of group 7A of the periodic table, (with group 7A including fluorine, chlorine, bromine, iodine and astatine). Another exemplary salt which is soluble in water, which can be utilized as bead-blasting media in various aspects of the invention, is ammonium chloride.

Halides are but one example of salts highly soluble in aqueous solvent. Numerous other salts besides halides are known to have high solubility in aqueous solvents, and such other salts can be utilized in various aspects of the invention. Non-halide salts soluble in aqueous solvent include, for example, various carbonates, such as, for example, calcium carbonate; and various hydroxides, including, for example, metal hydroxides. An exemplary carbonate is trona (Na₃(CO₃)(HCO₃))•2(H₂O).

The above-described aqueous solvent is but one of many types of solvent that can be utilized in various aspects of the invention, and it is to be understood that solvents other than water can be utilized for removing various bead-blasting media. For instance, various organic particles can be utilized as bead-blasting media, and can be subsequently solubolized in appropriate organic solvents. The organic particles can comprise organometallic materials in some aspects of the invention.

The utilization of soluble bead-blasting media can simplify cleaning of bead-blasted surfaces. Specifically, removal of the media with an appropriate solvent can eliminate the prior art problems associated with embedded bead-blasting particles, (exemplary prior art problems are discussed above in the “Background” section of this disclosure). In particular aspects, the utilization of highly soluble bead-blasting media can prevent potential arcing which can be associated with embedded beads, and can also help to promote adhesion of redeposited films on partible traps formed in accordance with aspects of the present invention.

Utilizing methodology of highly soluble beads and appropriate solvents for removing the beads can allow micro-scale surfaces to be formed (such as the surfaces shown in FIGS. 8 and 9) with few, if any, embedded beads. The substantially bead-free micro-scale roughened surfaces can provide minimal cyclic thermal stress due to the avoidance of bead contamination. Also, the substantially bead-free micro-scale roughened surfaces can have reduced sizes of re-deposited materials as opposed to sputter traps having substantially numbers of beads (such as, for example, beads of silicon carbide or aluminum oxide) associated therewith.

The above-discussed soluble media can be utilized to avoid problems associated with embedded bead-blasting media by enhancing removal of the media. In another aspect of the invention, problems associated with embedded bead-blasting media are alleviated by using media which is compatible with the desired use of the sputtering component being treated by such media. Accordingly, some of the media can remain embedded in the treated component without adversely affecting utilization of the component in a sputtering application.

An exemplary compatible media utilized for the bead-blasting of PVD components can comprise, consist essentially of, or consist of metal in elemental or alloy form. Generally, metallic materials are not utilized for bead-blasting in prior processes for treating PVD components because it is believed that the metallic materials are too soft. However, an aspect of the present invention is a recognition that suitably hard metallic materials can be utilized for bead-blast media. Although the metallic particles will generally be softer than conventional bead-blasting particles, the metallic particles can accomplish suitable roughening if the particles are at least as hard as the surface which is to be roughened. The hardness can be ascertained by any appropriate scale, including, for example, the Brinell scale, the Vickers scale, the Knoop scale, and the Mohs scale.

A metallic particle is considered compatible with a target surface if the particle either comprises the same composition as the target surface, or comprises something that will not impart undesired properties during a sputtering operation. For instance, if a sputtering target comprises tantalum and is to be utilized for forming a barrier layer, the bead-blasting particles utilized to roughen non-sputtered regions of the target can comprise, consist essentially of, or consist of one or more of titanium, molybdenum, tantalum, tungsten and cobalt, all of which can be utilized for forming barrier materials similarly to the tantalum of the target. Other materials which can be considered compatible with treated surfaces are materials which can be readily removed from the treated surfaces so that the particles are not associated with the surfaces in a sputtering operation. However, it will typically be difficult to remove metallic particles from a sputtering component surface, and accordingly the compatible metallic particles for a particular sputtering process will typically be particles formed of one or more materials having similar functions in semiconductor devices as a material being sputtered-deposited during the process.

The roughening of a tantalum-containing PVD component or titanium-containing PVD component can be of particular commercial importance. Sputter-deposition of tantalum or titanium, particularly deposition of tantalum or titanium in the presence of a nitrogen, can have more problems with re-deposition and adhesion along non-sputtered regions, and subsequent undesired particle formation, than does other processes. Tantalum or titanium is frequently sputter-deposited in the presence of nitrogen to form barrier materials comprising tantalum nitride or titanium nitride. Accordingly, methodologies for forming sputtering traps of the present invention can be particularly advantageous for treatment of tantalum or titanium sputtering targets utilized for formation of barrier materials.

Exemplary bead-blast materials comprising metallic media can be materials which contain from about 5% to about 30% metal powder (by volume), with such metal being at least about 99% pure, by weight. The bead-blast materials can comprise, for example, about 20% metal powder, and the remainder of the bead-blast material can be non-metallic particles, such as, for example, carbonate salts (sodium bicarbonate, potassium carbonate, trona, etc.), halide salts (sodium chloride, potassium chloride, etc), or any other suitable media. The components of the media utilized in addition to the metallic materials are preferably materials highly soluble in appropriate solvents so that such components can be readily removed from a treated surface. In some aspects, the bead-blasting media can be considered to comprise a first set of particles consisting essentially of one or both of metal alloy and elemental metal, and a second set of particles soluble in aqueous or organic solvent. The volume:volume (v/v) ratio of the first set of particles to the second set of particles within the media can be less than or equal to about 1:3, and in particular aspects is from greater than or equal to 1:10 to less than or equal to 1:3.

In a particular aspect of the invention, a tantalum target bonded to an aluminum backing plate is machined to produce grooves on the sidewall surface of the tantalum, and optionally on the surface of the aluminum, similar to the processing shown in FIGS. 4-7. The macro-roughened tantalum is then micro-roughened using a blend of tungsten powder (normally 200 grit at 80 psi) and baking soda (sodium bicarbonate) particles in a 1:10 volume ratio. The tungsten provides a blasting media that is hard enough to create a textured surface on the tantalum, but since tungsten adheres well to tantalum and does not have a contaminating effect on chambers utilized for formation of barrier materials, no problematic contaminants are introduced into the sputtering chamber through the utilization of the tantalum bead-blasting media. The initial blasting process can be followed by a pure baking soda blast to remove any loosely imbedded tungsten. Accordingly, any tungsten remaining in the particle trap will be firmly embedded in the target surface and will not fall into a chamber during a sputtering process. The micro-roughening can be conducted on a portion of the aluminum backing plate, as well as on a portion of the tungsten, to extend a particle-trapping region onto the aluminum backing plate, or alternatively can be conducted only on the macro-roughened regions of the tantalum. In some aspects, the macro-roughening of the tantalum surface can be omitted, and a the larger grit tungsten can be utilized at higher blasting pressure to create a rough surface. Such rough surface can be treated with further micro-roughening, or the micro-roughening can be omitted.

The tungsten powder of the above-discussed aspect of the invention can be utilized together with tantalum powder, or tantalum can be used in place of the tungsten powder. If the target is a titanium target, titanium powder can be used as the abrasive agent in a mixture with baking soda. Alternatively, the baking soda can be substituted with any suitable carrier particles. Preferably, the carrier particles will be easily removed, and accordingly the carrier particles will preferably be readily dissolved in a cleaning solvent utilized subsequent to the bead-blasting. The metallic particles can thus be utilized together with the highly-soluble particles discussed previously in this disclosure.

The sidewall 14 shown at the processing stage of FIGS. 8 and 9 can be considered to have a surface comprising a trapping area with both macro-scale and micro-scale structures therein. Specifically, projections 22 can have a length of 0.01 inches, and can be considered to be a macro-scale feature formed on a substrate. The divots formed within the projections can be considered to be micro-scale structures formed along surfaces of projections 22. The combination of the micro-scale and macro-scale structures can alleviate, and even prevent, the problems described previously in this disclosure regarding undesired incorporation of particles into sputter-deposited layers. The micro-scale structures formed across the macro-scale structures can, in some aspects, also advantageously alleviate, and in some cases entirely prevent, arcing that could otherwise occur in a PVD process.

Although the exemplary aspect of the invention described herein forms the microstructures on projections 22 after bending the projections, it is to be understood that the invention encompasses other aspects (not shown) in which the microstructures are formed prior to bending the projections. Specifically, projections 22 can be subjected to bead-blasting and/or chemical etching at the processing stage of FIG. 5, and subsequently bent, rather than being bent and subsequently subjected to bead-blasting and/or chemical etching.

The projections 22 of FIGS. 5-9 can be formed along some or all of the region 18 of FIG. 3. Accordingly, the projections can extend at least partially along sidewall 14 and/or at least partially along flange 16 and/or along non-sputtered laterally peripheral regions of face 12. In particular aspects, the projections will extend entirely along sidewall 14, and/or will extend entirely along flange 16 and/or will extend entirely along non-sputtered laterally peripheral regions of face 12.

FIGS. 2 and 3 illustrate a monolithic target construction. Persons of ordinary skill in the art will recognize that sputtering target constructions can also comprise target/backing plate constructions. Specifically, a sputtering target can be bonded to a backing plate prior to provision of the target in a sputtering chamber (such as the chamber described with reference to FIG. 1). The target/backing plate construction can have any desired shape, including the shape of the monolithic target of FIGS. 2 and 3. The backing plate can be formed of a material cheaper than the target, more easy to fabricate than the target, or having other desired properties not possessed by the target. The backing plate is utilized to retain the target in the sputtering chamber. The invention can be utilized to treat target/backing plate constructions in a manner analogous to that described in FIGS. 2-9 for treating a monolithic target construction.

FIGS. 10 and 11 illustrate an exemplary target/backing plate construction (or assembly) 200 which can be treated in accordance with methodology of the present invention. In referring to FIGS. 10 and 11 similar number will be utilized as was used above in describing FIGS. 2-4, where appropriate.

Construction 200 comprises a target 202 bonded to a backing plate 204. The target and backing plate join at an interface 206 in the shown assembly. The bond between target 202 and backing plate 204 can be any suitable bond, including, for example, a solder bond or a diffusion bond. Target 202 can comprise any desired material, including metals, ceramics, etc. In particular aspects, the target can comprise one of more of the materials described previously relative to the target 10 of FIGS. 2 and 3. Backing plate 204 can comprise any appropriate material or combination of materials, and frequently will comprise one or more metals, such as, for example, one or more of Al, Cu and Ti.

Construction 200 has a similar shape to the target construction 10 of FIGS. 2 and 3. Accordingly, construction 200 has a sputtering face 12, a sidewall 14 and a flange 16. Any of various non-sputtered surfaces of construction 200 can be treated with methodology of the present invention similarly to the treatment described above with reference to FIGS. 2-9. Accordingly, all or part of a shown region 18 of construction 200 can be treated.

A difference between construction 200 of FIG. 11 and construction 10 of FIG. 3 is that sidewall 14 of the FIG. 11 construction includes both a sidewall of a backing plate (204) and a sidewall of a target (202), whereas the sidewall 14 of the FIG. 3 construction included only a target sidewall. The treated region 18 of the FIG. 11 construction can thus include particle traps formed along a sidewall of backing plate 204 and/or particle traps formed along a sidewall of target 202. Additionally or alternatively, the treated region can comprise particle traps formed along flange 16 and/or can include particle traps formed along a non-sputtered portion of face 12. The particle traps can be formed with methodology identical to that described with reference to one or more of the aspects of FIGS. 4-9.

The target 202 of construction 200 can be treated to form particle traps along sidewall regions and/or non-sputtered regions of the sputtering face before or after the target is bonded to the backing plate. Similarly, the backing plate 204 of the construction can be treated to form particle traps along sidewall regions and/or flange regions before or after the backing plate is bonded to the target. Typically, both the target and the backing plate will have one or more surfaces treated to form particle traps, and the treatment of the target and/or backing plate of construction 200 will occur after bonding the target to the backing plate so that the target and backing plate can be concurrently treated.

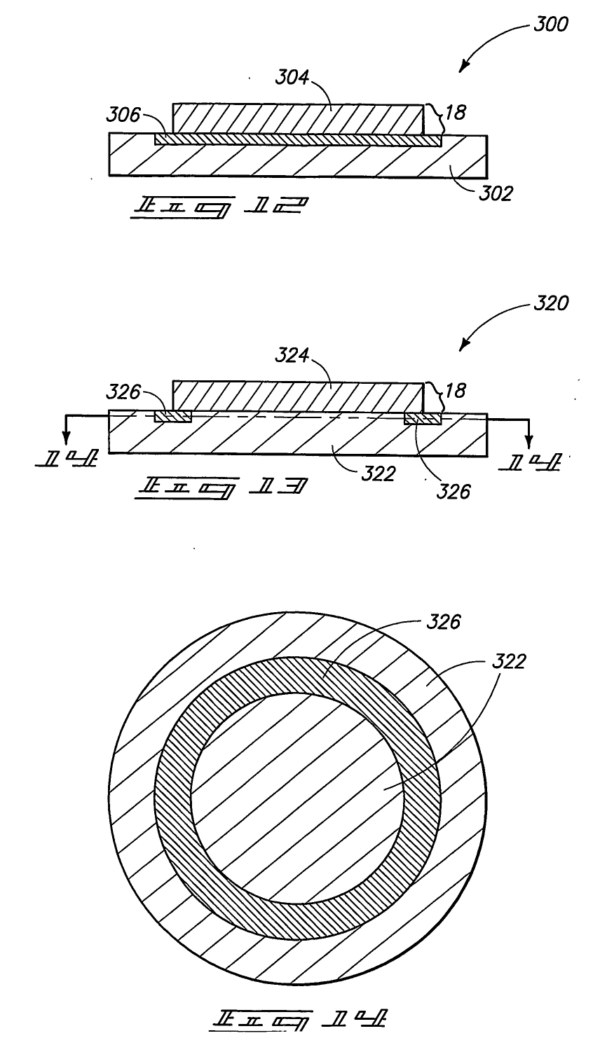

A further aspect of the invention is discussed with reference to FIGS. 12-14. A problem which can occur with the process described above for utilizing compatible metallic particles to form particle-trapping regions along target constructions is that the particles may adhere poorly to a backing plate of a target/backing plate construction even though the particles adhere well to the target. Accordingly, the particles may be incompatible with the backing plate, even though the particles are compatible with the target material. The embodiments of FIGS. 12-14 can overcome such problem.

FIG. 12 shows a target/backing plate construction 300 comprising a backing plate 302, a target 304, and an insert 306 between the target and backing plate. FIGS. 13 and 14 illustrate a target/backing plate construction 320 comprising a backing plate 322, a target 324, and an insert 326 between the target and backing plate. Each of the constructions 300 and 320 comprises a region 18 which is ultimately to be treated to form a particle trap, and such region comprises surfaces of the target (304 or 324) and insert (306 or 326), and does not comprise regions of the backing plate (302 or 322).

The targets of FIGS. 12-14 can comprise, for example, highly pure tantalum (such as, for example, tantalum having a purity of 99.9 weight % or higher), the backing plates can comprise copper or copper alloys (such as copper/zinc alloys, and in some aspects can be 99 weight % pure or higher in copper or copper alloy), and the insert regions can comprise tantalum, titanium or aluminum having a purity of 99 weight % or higher. Thus, the backing plates can be considered to comprise, consist essentially of, or consist of a first composition; the targets can be considered to comprise, consist essentially of, or consist of a second composition which is different from the first composition; and the inserts can be considered to comprise, consist essentially of, or consist of a third composition which is different from the first and second compositions. The target, backing plate and insert can be homogeneous in composition (as shown) or in other aspects one or more of the target, backing plate and insert can comprise multiple compositions (such as, for example, stacked layers of different compositions).

The various metals discussed above as being compatible with tantalum may not be compatible to copper, but would generally be compatible with titanium or aluminum in addition to being compatible with tantalum. Accordingly, the insert (306 or 326) is provided between the target and backing plate so that the particle-trapping region extends across metals compatible with the metallic particles which are ultimately to be utilized for treating the region. In some aspects, the invention includes a recognition that a Ta target bonded to a Cu alloy backing plate can have the particular problem that back-sputtered Ta will not stick to the Cu backing plate, and will thus readily peel off from the backing plate. The interlayer or ring material of the insert (306 or 326) can be selected to have better adhesion (chemical or metallurgical bonding) of Ta than the Cu backing plate material. The insert (306 or 326) can be a homogeneous single composition (as shown), or can comprise multiple compositions. Also, the shown insert can be replaced with a stack of several inserts in other aspects of the invention (not shown).

Regions 18 of FIGS. 12-14 can be treated utilizing the methodology described above with reference to FIGS. 5-9 so that the regions can comprise both macro-scale and micro-scale roughening, or alternatively can be treated only to form the micro-scale roughening. In aspects in which both micro-scale roughening and macro-scale roughening are utilized, the macro-scale roughening can occur before or after the micro-scale roughening. However, it is preferable for the macro-scale roughening to occur before the micro-scale roughening since the macro-scale roughening is coarser than the micro-scale roughening.

The difference between the embodiment of FIGS. 13 and 14 relative to that of FIG. 12 is that the insert 306 of FIG. 12 would be a solid circle, or other appropriate shape, when viewed from above; whereas the insert 326 of FIGS. 13 and 14 is annular when viewed from above, and in the shown embodiment is an annular circular ring when viewed from above. In some aspects, the insert 306 of FIG. 12 can be considered to be representative of a class of solid geometric shapes, and the insert 326 can be considered to be representative of a class of hollow geometric shapes.

The target of FIG. 12 can be considered to have a bonding surface which is entirely along the insert, and the target of FIGS. 13 and 14 can be considered to have a bonding surface which is partially along the insert and partially along the backing plate. In other words, the constructions of FIG. 12-14 illustrate that the insert is between at least a portion of the target and the backing plate, with the construction of FIG. 12 showing the insert between only a portion of the target and the backing plate, and the construction of FIGS. 13 and 14 showing the insert between an entirety of the target and the backing plate.

The constructions of FIGS. 12 and 13 can be formed by any suitable methods. For instance, in an exemplary method, the insert is first bonded to the backing plate with a suitable bond (including, for example, a solder bond or diffusion bond), and the target is subsequently bonded to the insert/backing plate combination with a suitable bond (including, for example, a solder bond or diffusion bond). Alternatively, the insert can be first bonded to the target with a suitable bond (including, for example, a solder bond or diffusion bond), and the target/insert combination can be subsequently bonded to the backing plate with a suitable bond (including, for example, a solder bond or diffusion bond). As yet another example, the target, backing plate and insert can all be simultaneously bonded to one another.

Regardless of how the target, backing plate and insert are bonded to one another, the particle-trapping regions can be formed over region 18 entirely after the bonding of the target, backing plate and insert to one another, or can be at least partially formed before the bonding of one or more of the target, backing plate and insert to one another. For instance, macro-roughened regions of the type shown in FIG. 5 can be formed along surfaces of the target andlor insert prior to bonding the target and/or insert into the target/backing plate construction. As another example, the bending of FIGS. 6 and 7 and/or micro-roughening of FIGS. 8 and 9 can be conducted along surfaces of the target and/or insert prior to bonding the target and/or insert into the target/backing plate construction. As yet another example, all of the processing steps of FIGS. 5-9 can be conducted after bonding of the target, backing plate and insert into a target/backing plate construction.

The methodology described above for treating non-sputtered regions of a sputtering target can be utilized for treating surfaces of numerous components suitable for utilization in numerous deposition processes (including physical vapor deposition (PVD) apparatuses, chemical vapor deposition (CVD) apparatuses, etc.), and can be utilized while maintaining desired roughness controls. For instance, the methodology can be utilized for treating surfaces of cups, pins, shields, coils, cover rings, clamps, chamber internal sidewalls, etc., of PVD apparatuses.

1. A method of treating a component of a deposition apparatus, the component comprising a composition having a first hardness, the method comprising exposing a surface of the component to bead blasting with bead-blasting media comprising particles having a second hardness greater than or equal to the first hardness, the particles consisting essentially of one or both of metal alloy and elemental metal.

2. The method of claim 1 wherein the component surface consists essentially of tantalum, and wherein the particles comprise one or more metallic components compatible with the tantalum.

3. The method of claim 1 wherein the component surface consists essentially of tantalum, and wherein the particles comprise one or more of titanium, molybdenum, tantalum, tungsten and cobalt.

4. The method of claim 1 wherein the component is a sputtering target consisting essentially of tantalum, and wherein the particles consist essentially of one or more of titanium, molybdenum, tantalum, tungsten and cobalt.

5. The method of claim 1 wherein the component is a sputtering target consisting essentially of tantalum, wherein the particles are a first set of particles comprised by the bead-blasting media, wherein the bead-blasting media comprises a second set of particles different from the first set of particles, wherein the first set of particles consist essentially of tungsten, the second set of particles consist essentially of sodium bicarbonate, and the volume ratio of the first set of particles to the second set of particles in the bead-blasting media is about 1:10.

6. The method of claim 1 further comprising:
forming a pattern of projections along the surface of the component; and
bending the projections.

7. The method of claim 6 wherein the component surface consists essentially of tantalum, and wherein the particles comprise one or more of titanium, molybdenum, tantalum, tungsten and cobalt.

8. The method of claim 6 wherein the bead blasting occurs before the forming of the pattern of projections.

9. The method of claim 6 wherein the bead blasting occurs after the forming of the pattern of projections and before the bending of the projections.

10. The method of claim 6 wherein the bead blasting occurs after the bending of the projections.

11. The method of claim 1 wherein the particles are a first set of particles comprised by the bead-blasting media, and wherein the bead-blasting media comprises a second set of particles different from the first set of particles, the second set of particles being soluble in aqueous solution.

12. The method of claim 11 wherein a volume:volume ratio of the first set of particles to the second set of particles within the bead-blasting media is less than or equal to about 1:3.

13. The method of claim 11 wherein a volume:volume ratio of the first set of particles to the second set of particles within the bead-blasting media is less than or equal to about 1:3 and greater than or equal to about 1:10.

14. The method of claim 11 wherein the second set of particles comprise one or more salts selected from the group consisting of alkali halide salts and ammonium halide salts.

15. The method of claim 11 wherein the second set of particles comprise one or more salts selected from the group consisting of metal hydroxides.

16. The method of claim 11 wherein the second set of particles comprise one or more salts selected from the group consisting of halide salts comprising elements selected from groups 1A and 2A of the periodic table.

17. The method of claim 1 wherein the particles are a first set of particles comprised by the bead-blasting media, and wherein the bead-blasting media comprises a second set of particles different from the first set of particles, the second set of particles being soluble in an organic solution.

18. The method of claim 17 wherein the second set of particles comprises one or more organometallic materials.

19. A method of forming a target/backing plate construction, comprising:
providing a backing plate comprising a first composition;
providing a target comprising a second composition different from the first composition;
providing an insert having a third composition different from the first and second compositions;
bonding the target, backing plate and insert into a configuration in which the insert is between at least a portion of the target and the backing plate; the configuration having a surface which extends along a portion of the target and a portion of the insert; and
forming a particle-trapping region along said surface, the particle-trapping region comprising a pattern of curved projections which extend along the portion of the insert and along the portion of the target, the curved projections forming cavities, at least some of the cavities opening laterally along the target/backing plate construction.

20. The method of claim 19 wherein the forming the particle-trapping region occurs after the bonding and comprises:
forming a pattern of projections along the surface;
bending the projections; and
exposing the projections to bead blasting to form microstructures on the projections.

21. The method of claim 19 wherein the bead blasting utilizes a media comprising particles having a hardness greater than or equal to a hardness of the second composition, the particles consisting essentially of one or both of metal alloy and elemental metal.

22. The method of claim 21 wherein the particles are a first set of particles comprised by the bead-blasting media, and wherein the bead-blasting media comprises a second set of particles different from the first set of particles, the second set of particles being soluble in aqueous solution or organic solution.

23. The method of claim 19 wherein at least some of the particle-trapping region is formed before the bonding.

24. The method of claim 19 wherein the bonding comprises:
insetting the insert within the backing plate and bonding the insert to the backing plate; and
bonding the target to the insert after the insert is bonded to the backing plate.

25. The method of claim 19 wherein the second composition comprises tantalum.

26. The method of claim 19 wherein the second composition consists essentially of tantalum.

27. The method of claim 19 wherein the second composition consists of tantalum.

28. The method of claim 19 wherein the first composition comprises copper; the second composition comprises tantalum; and the third composition comprises titanium.

29. The method of claim 19 wherein the first composition comprises copper; the second composition consists essentially of tantalum; and the third composition consists essentially of titanium.

30. The method of claim 19 wherein the first composition comprises copper; the second composition consists of tantalum; and the third composition consists of titanium.

31. The method of claim 19 wherein the second composition comprises tantalum, and the third composition comprises one or more of aluminum, tantalum and titanium.

32. The method of claim 19 wherein the target has a bonding surface proximate the backing plate, and wherein an entirety of said bonding surface is in contact with the insert.

33. The method of claim 19 wherein the target has a bonding surface proximate the backing plate, and wherein only a portion of said bonding surface is in contact with the insert.

34. The method of claim 19 wherein the insert is a solid geometric shape of the third composition.

35. The method of claim 19 wherein the insert is a hollow geometric shape of the third composition.

36. The method of claim 19 wherein the insert is a solid circle of the third composition.

37. The method of claim 19 wherein the insert is an annular ring of the third composition.

38. A target/backing plate construction, comprising:
a backing plate comprising a first composition;
a target comprising a second composition different from the first composition;
an insert between at least a portion of the target and the backing plate, the insert having a third composition different from the first and second compositions;
the target/backing plate construction comprising a particle-trapping region extending along a portion of the target and along a portion of the insert, the particle-trapping region comprising a pattern of curved projections which extends along the portion of the insert and along the portion of the target, the curved projections forming cavities, at least some of the cavities opening laterally along the target/backing plate construction.

39. The construction of claim 38 wherein the second composition comprises tantalum.

40. The construction of claim 39 wherein the third composition comprises titanium.

41. The construction of claim 38 wherein the second composition consists essentially of tantalum.

42. The construction of claim 41 wherein the third composition comprises titanium.

43. The construction of claim 38 wherein the second composition consists of tantalum.

44. The construction of claim 43 wherein the third composition comprises titanium.

45. The construction of claim 38 wherein the first composition comprises copper; the second composition comprises tantalum; and the third composition comprises titanium.

46. The construction of claim 38 wherein the first composition comprises copper; the second composition consists essentially of tantalum; and the third composition consists essentially of titanium.

47. The construction of claim 38 wherein the first composition comprises copper; the second composition consists of tantalum; and the third composition consists of titanium.

48. The construction of claim 38 wherein the second composition comprises tantalum, and the third composition comprises one or more of aluminum, tantalum and titanium.

49. The construction of claim 38 wherein the target has a bonding surface proximate the backing plate, and wherein an entirety of said bonding surface is in contact with the insert.

50. The construction of claim 38 wherein the target has a bonding surface proximate the backing plate, and wherein only a portion of said bonding surface is in contact with the insert.

51. The construction of claim 38 wherein the insert is a solid geometric shape of the third composition.

52. The construction of claim 38 wherein the insert is a hollow geometric shape of the third composition.

53. The construction of claim 38 wherein the insert is a solid circle of the third composition.

54. The construction of claim 38 wherein the insert is a solid circle of the third composition and is inset within the backing plate.

55. The construction of claim 38 wherein the insert is an annular ring of the third composition.

56. The construction of claim 38 wherein the insert is an annular ring of the third composition and is inset within the backing plate.
